(19) United States
(12) Patent Application Publication
(10) Pub. No.: US 2025/0181948 A1
(43) Pub. Date: Jun. 5, 2025

(54) QUANTUM FEATURE MAPPING SYSTEMS AND METHODS

(71) Applicant: State Farm Mutual Automobile Insurance Company, Bloomington, IL (US)

(72) Inventors: Zhoushen Huang, Westmont, IL (US); Adrian Bolt, Richardson, TX (US); Michael H. Skelton, Austin, TX (US); Satvik Duddukuru, Plano, TX (US)

(21) Appl. No.: 18/783,159

(22) Filed: Jul. 24, 2024

Related U.S. Application Data
(60) Provisional application No. 63/605,901, filed on Dec. 4, 2023.
(60) Provisional application No. 63/620,062, filed on Jan. 11, 2024.

(51) Int. Cl. G06N 10/20

(52) U.S. Cl. CPC G06N 10/20

(57) ABSTRACT

A computing device including a memory and a processor is disclosed. The processor is programmed to: (i) generate a quantum feature map and compute a quantum wave function and a plurality of projection operators for each quantum wave function corresponding to each classical data input; (ii) generate a respective quantum density operator for a positive class and a negative class; (iii) evaluate a difference between a first expectation value corresponding to the positive class for the respective quantum density operator and a second expectation value corresponding to the negative class for the respective quantum density operator; and/or (iv) compute a first average value and a second average value of the difference between the first expectation value and the second expectation value for each classical data point in the positive class and in the negative class, respectively, for generating a metric value.

### CROSS-REFERENCE TO RELATED APPLICATIONS

This application claims priority to U.S. Provisional Patent Application No. 63/620,062, filed Jan. 11, 2024, entitled “QUANTUM FEATURE MAPPING SYSTEMS AND METHODS,” and U.S. Provisional Patent Application No. 63/605,901, filed Dec. 4, 2023, entitled “QUANTUM FEATURE MAPPING SYSTEMS AND METHODS,” the entire contents of which are hereby incorporated by reference in their entirety.

### FIELD OF THE DISCLOSURE

The present disclosure generally relates to quantum computation, and, more particularly, to systems and methods for evaluating a quantum feature map including translating a representation of classical data to quantum space as input to a quantum circuit.

### BACKGROUND

In today's hybrid quantum machine learning algorithms, one of the more crucial steps that may need to be performed involves translating classical data to their quantum mechanical representation. Such representations, due to their potential in leveraging unique quantum characteristics such as entanglement, may offer new insight into the data that may be hard to come by in classical data embedding techniques.

How well the quantum representation is, generally, may place a fundamental upper limit in the predictive power of the overall learning algorithm. Once this translation is accomplished, the task to learn from the quantum representation may either be handed over to (i) a classical algorithm, an example being the Quantum Support Vector Machine, or to (ii) other quantum processes, such as variational quantum circuits, if further quantum advantages can be expected to be leveraged, for example, in finding a classifying hyperplane.

Currently known methods of evaluating a classical-to-quantum mechanical representation, which is generally known as a quantum feature map, have certain drawbacks, such as an evaluation of the quantum feature map may rely upon an arbitrarily chosen reference kernel, and, therefore, the evaluation of the quantum feature map may vary in accordance with the chosen reference kernel. In addition, the current known methods of evaluating classical-to-quantum mechanical representation may be based upon a support vector machine (SVM) algorithm, and, therefore, the evaluation may depend upon the predictive performance of the SVM algorithm.

Accordingly, there exists a need for systems and methods for evaluating a classical-to-quantum mechanical representation, in which the above-mentioned drawbacks are not present. Conventional techniques may include additional drawbacks, inefficiencies, ineffectiveness, and/or encumbrances, as well.

### BRIEF SUMMARY

The present embodiments may relate to, inter alia, computer-implemented methods and computer systems for developing a metric for evaluating a classical-to-quantum mechanical representation (or a quantum feature map) based upon the quantum feature map itself. In particular, the metric for evaluating the quantum feature map is generated or derived using quantum density metrices, which are the natural language in quantum physics for describing a collection of quantum wave functions resulting from a physical experiment (or test).

In one aspect, a computer system for translating a representation of classical data to quantum space as input to a quantum circuit may be provided. The computer system may include one or more local or remote processors, servers, computing devices or classical computing devices, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, a computing device may include at least one memory and at least one processor in communication with the at least one memory. The at least one processor may be programmed to: (i) generate a quantum feature map corresponding to a quantum circuit; (ii) using the quantum feature map, compute a quantum wave function corresponding to each classical data point; (iii) compute a plurality of projection operators for each quantum wave function corresponding to each classical data input; (iv) generate a respective quantum density operator for a positive class and a negative class based upon a sum of the plurality of projection operators and a count of the plurality of projection operators; (v) for each quantum wave function corresponding to each classical data point, evaluate a difference between a first expectation value corresponding to the positive class for the respective quantum density operator and a second expectation value corresponding to the negative class for the respective quantum density operator; (vi) compute a first average value of the difference between the first expectation value and the second expectation value for each classical data point in the positive class; (vii) compute a second average value of the difference between the first expectation value and the second expectation value for each classical data point in the negative class; and/or (viii) based upon a difference between the first average value and the second average value, generate a metric value. As a result, a classical computing device, a quantum circuit and/or a quantum feature map may be enhanced; the effectiveness of the classical computing device, the quantum circuit and/or the quantum feature map may be improved; and/or variational parameters may be optimized or otherwise enhanced. The computer system may include additional, less, or alternate functionality, including that discussed elsewhere herein.

In another aspect, a computer-implemented method may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. The computer-implemented method may include (i) generating a quantum feature map corresponding to a quantum circuit; (ii) using the quantum feature map, computing a quantum wave function corresponding to each classical data point; (iii) computing a plurality of projection operators for each quantum wave function corresponding to each classical data input; (iv) generating a respective quantum density operator for a positive class and a negative class based upon a sum of the plurality of projection operators and a count of the plurality of projection operators; (v) for each quantum wave function corresponding to each classical data point, evaluating a difference between a first expectation value corresponding to the positive class for the respective quantum density operator and a second expectation value corresponding to the negative class for the respective quantum density operator; (vi) computing a first average value of the difference between the first expectation value and the second expectation value for each classical data point in the positive class; (vii) computing a second average value of the difference between the first expectation value and the second expectation value for each classical data point in the negative class; and/or (viii) based upon a difference between the first average value and the second average value, generating a metric value. The computer-implemented method may include additional, less, or alternate functionality, including that discussed elsewhere herein.

In yet another aspect, a non-transitory computer-readable medium (CRM) embodying programmed instructions may be provided. The instructions, when executed by at least one processor of a computing device (or one or more local or remote processors, servers, classical computing devices, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another), cause and/or direct the at least one processor to perform one or more of the following operations: (i) generate a quantum feature map corresponding to a quantum circuit; (ii) using the quantum feature map, compute a quantum wave function corresponding to each classical data point; (iii) compute a plurality of projection operators for each quantum wave function corresponding to each classical data input; (iv) generate a respective quantum density operator for a positive class and a negative class based upon a sum of the plurality of projection operators and a count of the plurality of projection operators; (v) for each quantum wave function corresponding to each classical data point, evaluate a difference between a first expectation value corresponding to the positive class for the respective quantum density operator and a second expectation value corresponding to the negative class for the respective quantum density operator; (vi) compute a first average value of the difference between the first expectation value and the second expectation value for each classical data point in the positive class; (vii) compute a second average value of the difference between the first expectation value and the second expectation value for each classical data point in the negative class; and/or (viii) based upon a difference between the first average value and the second average value, generate a metric value. The non-transitory CRM may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary diagram of an ensemble of quantum computing devices for executing a quantum application on a quantum computing device.

FIG. 2 depicts an exemplary configuration of an application server (or a classical computing device).

FIG. 3 depicts a flow-chart of exemplary computer-implemented method operations performed by a classical computing device such as a control computing device shown in FIG. 1.

FIGS. 4A and 4B depict another flow-chart of exemplary computer-implemented method operations performed by a classical computing device such as a control computing device shown in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, network-based systems and methods for evaluating a quantum feature map including translating a representation of classical data to quantum space as input to a quantum circuit. Recent developments in quantum computing have pushed quantum computers closer to solving classically intractable problems. Existing quantum programming languages and compilers use a quantum assembly language composed of 1- and 2-quantum bit (“qubit”) gates to prepare and execute primitive operations on quantum computers. Recent advancements in hardware and software include devices including, but not limited to. IBM's 50-qubit quantum machine (and/or machines having a greater qubit count) and Google's 72-qubit machine, as well as classical-quantum hybrid algorithms tailored for such Noisy Intermediate-Scale Quantum (“NISQ”) machines, such as Quantum Approximate Optimization Algorithm (“QAOA”) and Variational Quantum Eigensolver (“VQE”). Further advancements in hardware and software may include commercially accessible quantum computing devices from IBM and/or others having a qubit count in the low hundreds, and, in some cases, experimental quantum computing device having a qubit count of approximately 1000 qubits.

When the classically intractable problems are targeted for solving using quantum computing, as described herein, a crucial step, and arguably the most important step, is in translating the classical data to its quantum mechanical representation. Such representations, due to their potential in leveraging unique quantum characteristics such as entanglement, offer new insights into the data that may be hard to come by in classical data embedding techniques. A particular way in which the classical data is represented for input to a quantum circuit places a fundamental upper limit in the predictive power of the overall learning algorithm. Accordingly, the particular translation of the classical data into a quantum space as an input to a quantum circuit, which is referred to as a quantum feature map, needs to be evaluated to quantify that the quantum feature map meets certain threshold criteria.

The currently known methods for evaluating a quantum feature map are based upon a quantum wave function that is a mathematical object that encodes the classical data. In other words, the quantum wave function provides a mathematical description of a quantum state of a quantum particle as a function of momentum, time, position, and spin. As it is generally known, a quantum analog of a classical bit (or a binary bit) is a qubit, and the qubit has a state that corresponds with properties of a quantum particle, such as momentum, time, position, and spin. The wave function of a single qubit is a function of spin and time. The wave function is generated as a consequence of the quantum feature map, which may be described as the quantum state of the entire quantum computing device, and may include, among other things, crucial information such as entanglement between different qubits, which may not be adequately reflected from single-qubit descriptions, such as a single qubit wave function or a single qubit density matrix. Upon execution of the quantum circuit parametrized by classical data, the qubits may either be measured and analyzed using classical algorithms, or further transformed by other quantum processes or circuits without first being measured as that may destroy some quantum information. The qubits measurement data may be analyzed using a classical algorithm (e.g., support vector machine (SVM) algorithm) or other quantum processes or circuits (e.g., variational quantum circuits). While the qubit measurement data depends on the quantum circuit and the fidelity of the quantum circuit, the qubit measurement data also depends at least in part on the quantum feature map. The quantum feature map can thus be evaluated using the quantum wave function, which describes how the quantum mechanical representation of the classical data may undergo changes in momentum, time, position, and spin as they propagate through the quantum circuit.

However, direct measurement of the quantum wave function is generally not possible or not practical, and, as a result, metrics such as a kernel metric, a quantum kernel alignment metric, and/or more complicated transformations are used. The quantum kernel alignment, as described herein, may use a classical kernel alignment technique, which may be based upon an arbitrarily selected reference kernel. Therefore, an evaluation of the quantum feature map will be different in accordance with the selected reference kernel.

Additionally, the kernel metric and/or the quantum kernel alignment metric may be based upon the principles of the traditional support vector machine (SVM) algorithm. An evaluation of the quantum feature map using methods that are based upon principles of the traditional SVM algorithm may be limited by the predictive performance of the SVM algorithm. Therefore, the currently known methods of evaluating the quantum feature map do not provide an intrinsic measure of the quantum feature map.

Various embodiments in the present disclosure describe a metric for evaluating the quantum feature map based upon the quantum feature map itself. The metric, according to exemplary embodiments, as described in the present disclosure, may be based upon the notion of quantum density metrics. The quantum density matrix formalism generalizes the classical concept of probability distribution to quantum theory and provides the complete description of a collection of quantum wave functions in natural language. In other words, if the quantum feature map and the classical data are considered analogous to an experiment and its experimental parameters, respectively, in which a quantum state as an outcome is produced, then a collection (or an ensemble) of quantum states produced by repeated experiments (or repeated sampling of classical data) may be described in natural language by the quantum density matrix.

Accordingly, in some embodiments, and by way of a non-limiting example, if the quantum feature map is considered as an experimental black box, and experiments to be performed with experimental conditions are represented by classical data χᵢ, then two different sets of experimental conditions may be labeled as Yiϵ{±1}. The quantum density matrix (or density matrix) may be represented by the following equation shown as equation 1.

$$\begin{matrix}{ρ}_{\pm } = \frac{1}{{N}_{\pm }} {\sum }_{i : {y}_{i} = \pm 1} & \vert {ψ}_{i} 〉 〈 {ψ}_{i} \vert , Tr {ρ}_{\pm } = 1\end{matrix} \qquad ( 1 )$$

In equation 1 above, N_{±} represents respective sample sizes of the two classes (or the two different sets of experimental conditions), and with N_{±}→∞, ρ_{±} may approach a faithful representation of the labels ± (“ground truth”) independent of the sampling of experimental conditions.

In some embodiments, for a new state |ϕ [symbol] that is prepared by the same experiment, but with unknown experimental conditions, the probability of observing this state in either ensemble may be represented by the following equation shown as equation 2.

$${P}_{\pm } ( ϕ ) = 〈 ϕ \vert {ρ}_{\pm } \vert ϕ 〉 \qquad ( 2 )$$

A reasonable prediction of the label may be given by the relative strength of the two classes, as shown by the following equation that is shown as equation 3.

$$\tilde{y} ( ϕ ) = sgn [ {P}_{+} ( ϕ ) - {P}_{-} ( ϕ ) ] = Sgn 〈 ϕ \vert Δρ \vert ϕ 〉 , Δ ρ ≡ {ρ}_{+} - {ρ}_{-} \qquad ( 3 )$$

Accordingly, trace-normalizing ρ_{±} may separately ensure that the two classes are treated on an equal footing even if there is class imbalance in the sampling. Further, signal strength corresponding to an unseen data point ϕ may be represented by the following equation that is shown as equation 4. And, for a data point that is already sampled, self-signal may be eliminated by removing that particular sample from the ensemble before computing the score, as shown in equation 5 below.

$$f ( ϕ ) = 〈 ϕ \vert Δρ \vert ϕ 〉 \qquad ( 4 )$$

$${f}^{'} ( {ψ}_{i} ) = f ( {ψ}_{i} ) - \frac{{y}_{i}}{{N}_{{y}_{i}}} \qquad ( 5 )$$

Accordingly, a lager value of yᵢf′(ψᵢ) may represent the stronger signal of ψᵢ in Δρ. Similarly, a negative value of yᵢf′(ψᵢ) may represent a wrong signal. An average sign-weighted score of the positive and negative samples, and an overall score of all samples may be represented by the equation 6 and equation 7, respectively, as shown below.

$$\begin{matrix}{F}_{\pm } = \frac{1}{{N}_{\pm }} {\sum }_{i : {y}_{i} = \pm 1} & {y}_{i} {f}^{'} ( {ψ}_{i} ) = \pm Tr ( {ρ}_{\pm } Δ ρ ) - \frac{1}{{N}_{\pm }}\end{matrix} \qquad ( 6 )$$

$$\tilde{F} ≡ {F}_{+} + {F}_{-} = T r [ {( Δ ρ )}^{2} ] - \frac{1}{{N}_{+}} - \frac{1}{{N}_{-}} \qquad ( 7 )$$

In the above, the scores F_{±} are normalized with the population size of the respective classes to factor out or determine sampling imbalance, and their sum serves as a measure of class separability. For two different feature maps ψ and ψ′ corresponding to two different experimental setups, and for N_{±} that remains the same for both experimental setups, their separating power may be compared using the equation 8, shown below.

$$F ( Ψ ) ≡ T r [ {( Δ ρ ( Ψ ) )}^{2} ] \qquad ( 8 )$$

In the above equations, \tilde{F} represents an average signal strength of in-sample data, and F represents an average signal strength of out-of-sample data. In some embodiments, F may be represented in terms of the kernel matrix of the sampled data. An inner product between two pure states, in accordance with the quantum machine learning principles may be represented as the trace similarity of their projectors, as shown in the equation 9 below.

$$K ( ψ , ϕ ) ≡ Tr [ \vert ψ 〉 〈 ψ \vert ϕ 〉 〈 ϕ \vert ] = {\vert 〈 ψ \vert ϕ 〉 \vert}^{2} \qquad ( 9 )$$

In the non-orthogonal basis of all samples {ψᵢ [symbol] ψᵢ|}, Δρ with coordinates {rᵢ} may be represented as shown by equation 10 below.

$$Δρ = {\sum }_{i} {r}_{i} \vert {ψ}_{i} 〉 〈 {ψ}_{i} \vert , {r}_{i} = \frac{{y}_{i}}{{N}_{{y}_{i}}} \qquad ( 10 )$$

Accordingly, the F score may be square length of Δρ, which in coordinate form may be presented as equation 11 shown below.

$$F = T r ( Δ {ρ}^{2} ) = {\sum }_{i , j} {r}_{i} {r}_{j} K ( {ψ}_{i} , {ψ}_{j} ) \qquad ( 11 )$$

Similarly, \tilde{F} may be represented in coordinate form as shown in equation 12 below.

$$\tilde{F} = {\sum }_{i , j} {r}_{i} {r}_{j} \tilde{K} ( {ψ}_{i} , {ψ}_{j} ) , \tilde{K} = K - 𝒥 \qquad ( 12 )$$

In the above, \tilde{K} matrix is obtained from K by eliminating its diagonal line. While K is non-negative definite, \tilde{K} may not be non-negative definite, and, therefore, cannot be interpreted as a kernel. Additionally, the sum of rᵢ is, by construction, identically 0, as shown below using equation 13, which corresponds with the class balancing normalization in constructing Δρ.

$${\sum }_{i} {r}_{i} = 0 \qquad ( 13 )$$

In some embodiments, the dual form of SVM classifier, the Lagrange multipliers have the following constraint that is represented by equation 14 as show below.

$${\sum }_{i} {r}_{i}^{s v m} = 0 , {r}_{i}^{s v m} = {y}_{i} {a}_{i} \qquad ( 14 )$$

In some embodiments, the support vectors may have their corresponding multipliers aᵢ that are greater than 0 meaning their corresponding slack constraint in the primal problem is active, and training data falling to the correct side of the classifying hyperplane will have aᵢ equal to 0 and may not have any contribution to the trained classifier.

Equation 14 described above may come from the stationarity of the hyperplane's intercept upon minimizing the Lagrange-auxiliarated cost function of the primal problem. Accordingly, the optimal solution to the SVM may include emergent class balancing that is built into Δρ. In other words, the SVM classifier is equivalent to Δρ such that sampling data points that are support vectors (with sampling weight aᵢ). Accordingly, the Δρ metric is like an SVM with prescribed weights aᵢ=1/N_{y}_{ᵢ}.

The various embodiments in the present disclosure thus assist a user in selecting the most appropriate quantum feature map that produces outcomes that differ only within a small threshold value for each execution of the quantum circuit using the quantum feature map. In particular, the most appropriate quantum feature map may be determined using the score F calculated using the feature map itself. Additionally, or alternatively, kernel matrix may also be generated from the calculated score F. These embodiments are described herein using the figures described below.

### Exemplary Quantum Computing System

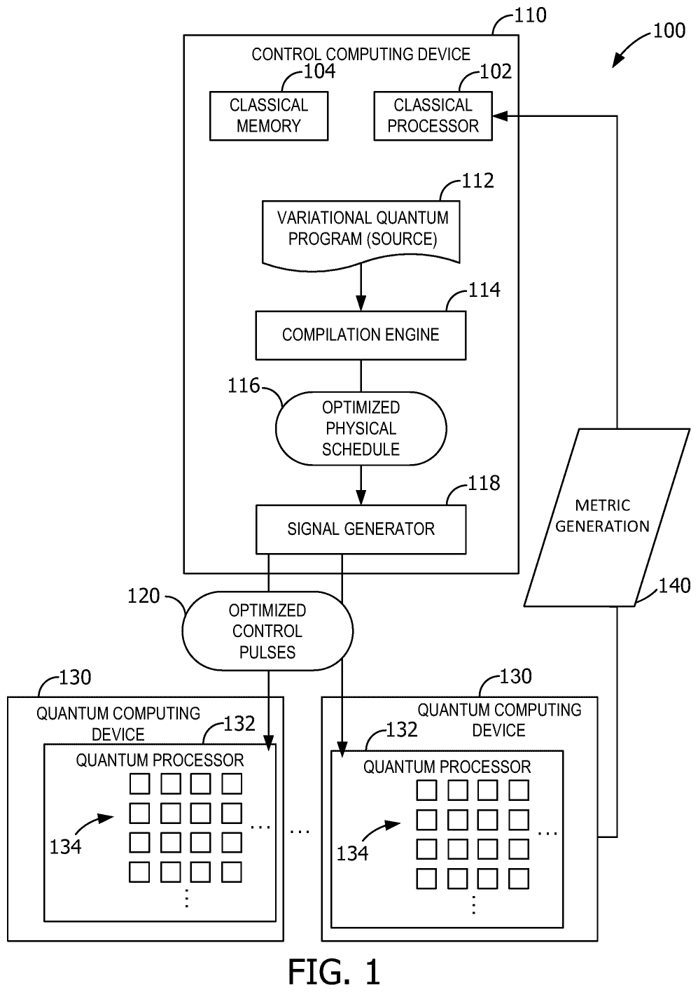

FIG. 1 depicts an exemplary diagram of exemplary ensemble of quantum computing devices 100 for executing a quantum application on a quantum computing device 130. The ensemble of quantum computing devices 100 may include a control computing device 110 that is configured to prepare (e.g., compile and optimize) a quantum application program (also referred to as a quantum feature map) 112 for execution on the quantum computing devices 130s. In particular, different quantum application operations of the quantum application may be executed in parallel using the quantum computing devices 130s. More than one quantum computing device of the plurality of quantum computing devices 130s may perform a particular or a respective quantum application operation of the quantum application operations of the quantum feature map 112 in parallel.

The control computing device 110 may include a classical processor 102 (e.g., a central processing unit (“CPU”), an x86-based processor, or the like) that can be configured to execute classical processor instructions, a classical memory 104 (e.g., random access memory (“RAM”), memory SIMM, DIMM, or the like, which includes classical bits of memory). A quantum computing device 130 of the quantum computing devices 130s may include multiple qubits 134 that represent a quantum processor 132 upon which the quantum application program 112 is executed.

In some examples, the quantum application program 112 may be a variational quantum application program that interleaves compilation with computation during runtime, and the quantum processor 132 may include 50 or 100 qubits. However, it should be understood that the present disclosure is envisioned to be operable and beneficial for quantum processors with any number of qubits, for example, many tens, hundreds, or more qubits 134.

The fundamental unit of quantum computation is a quantum bit (or a qubit) 134. In contrast to classical bits (“cbits”), qubits are capable of existing in a superposition of logical states, notated herein as |0 [symbol] and |1 [symbol] . The general quantum state of a qubit may be represented as:

$$\vert {ψ}_{1} 〉 = α \vert 0 〉 + β \vert 1 〉 ,$$

where α, β are complex coefficients with |α|²+|β|²=1. When measured in the 0/1 basis, the quantum state collapses to |0 [symbol] or |1 [symbol] with a probability of |α|² and |β|², respectively. The qubit 134 can be visualized as a point on a 3D sphere called the Bloch sphere. Qubits 134 can be realized on different Quantum Information Processing (QIP) platforms, including ion traps, quantum dot systems, and, in the example embodiment, superconducting circuits. The number of quantum logical states grows exponentially with the number of qubits 134 in the quantum processor 132. For example, a system with three qubits 134 can live in the superposition of eight logical states: |000 [symbol] , |001 [symbol] |010 [symbol] , |011 [symbol] , . . . , |111 [symbol] . This property sets the foundation of potential quantum increased speed over classical computation. In other words, an exponential number of correlated logical states can be stored and processed simultaneously by the quantum system 100 with a linear number of qubits 134.

A quantum algorithm may be described in terms of a quantum circuit. During quantum compilation, the quantum application program 112 may be first decomposed into a set of 1- and 2-qubit discrete quantum operations called logical quantum gates. These quantum gates are represented in matrix form as unitary matrices. 1-qubit gate correspond to rotations along a particular axis on the Bloch sphere. In an exemplary quantum instruction set architecture (“ISA”), the 1-qubit gate set may include rotations along the x-, y-, and z-axes of the Bloch sphere. Such gates are notated herein as Rₓ, R_{y}, and R_{z} gates, respectively. Further, the quantum ISA may also include a Hadamard gate, which corresponds to a rotation about the diagonal x+z axis. An example of a 2-qubit logical gate in the quantum ISA is a Controlled-NOT (“CNOT” or “CX”) gate, which flips the state of the target qubit if the control qubit is |1 [symbol] or leaves the state unchanged if the control qubit is |0 [symbol] . For example, the CX gate sends |10 [symbol] to |11 [symbol] , sends |11 [symbol] to |10 [symbol] , and preserves the other logical states.

Further, it should be understood that the general logical assembly instructions typically used during compilation of the variational quantum application program 112 were designed without direct consideration for the variations in the types of quantum computing devices that may be used. As such, there is often a mismatch between the logical instructions and the capabilities of the particular quantum information processing (QIP) platform. For example, on some QIP platforms, it may not be obvious how to implement the CX gate directly on that particular physical platform. As such, a CX gate may be further decomposed into physical gates in a standard gate-based compilation. Other example physical quantum gates for various architectures include, for example, in platforms with Heisenberg interaction Hamiltonian, such as quantum dots, the directly implementable 2-qubit physical gate is the VSWAP gate, which implements a SWAP when applied twice. In platforms with ZZ interaction Hamiltonian, such as superconducting systems of Josephson flux qubits and NMR quantum systems, the physical gate is the CPhase gate, which is identical to the CX gate up to single qubit rotations. In platforms with XY interaction Hamiltonian, such as capacitively coupled Josephson charge qubits (e.g., transmon qubits), the 2-qubit physical gate is iSWAP gate. For trapped ion platforms with dipole-chain interaction, two popular physical 2-qubit gates are the geometric phase gate and the XX gate.

The quantum processor 132 may be continuously driven by external physical operations to any state in the space spanned by the logical states. The physical operations, called control fields, are specific to the underlying system, with control fields and system characteristics controlling a unique and time-dependent quantity called the Hamiltonian. The Hamiltonian determines the evolution path of the quantum states. For example, in superconducting systems such as the example quantum computing device 130, the qubits 134 can be driven to rotate continuously on the Bloch sphere by applying microwave electrical signals. By varying the intensity of the microwave signal, the speed of rotation of the qubit 134 can be manipulated. The ability to engineer the system Hamiltonian in real-time allows the quantum computing system 100 to direct the qubits 134 to the quantum state of interest through precise control of related control fields. Thus, quantum computing may be achieved by constructing a quantum system in which the Hamiltonian evolves in a way that aligns with a high probability upon final measurement of the qubits 134. In the context of quantum control, quantum gates may be regarded as a set of pre-programmed control fields performed on the quantum processor 132.

During operation, the control computing device 110 implements a quantum algorithm, attempting to create as efficient a quantum circuit as possible, where efficiency may be in terms of circuit width (e.g., number of qubits) and depth (e.g., length of critical path, or runtime of the circuit). In some embodiments, the compilation engine 114 optimizes various circuits or subcircuits using, for example, IBM Qiskit transpiler, which applies a variety of circuit identities (e.g., aggressive cancellation of CX gates and Hadamard gates). In some embodiments, the compilation engine 114 also performs additional merging of rotation gates (e.g., Rₓ(α) followed by Rₓ(β) merges into Rₓ(α+β)) to further reduce circuit sizes.

At the lowest level of hardware, quantum computers are controlled by analog pulses. Therefore, quantum compilation translates from a high-level quantum algorithm down to a sequence of control pulses 120. Once a quantum algorithm has been decomposed into a quantum circuit comprising single- and two-qubit gates, gate-based compilation can be performed by concatenating a sequence of pulses corresponding to each gate. In particular, a lookup table maps from each gate in the gate set to a sequence of control pulses that executes that gate. Pure gate-based compilation provides an advantage in short pulse compilation time, as the lookup and concatenation of pulses can be accomplished very quickly.

Some known methods of compilation for variational algorithms use the gate-based approach to compilation, using parameterized gates such as Rₓ(θ) and R_{z}(ϕ). However, the pure gate-based compilation approach may prevent the optimization of pulses from happening across the gates because there might exist a global pulse for an entire circuit that is shorter and more accurate than the concatenated one. The quality of the concatenated pulse may rely heavily on an efficient gate decomposition of the quantum algorithm. GRAPE is a strategy for compilation that numerically finds the best control pulses needed to execute a quantum circuit or sub-circuit by following a gradient descent procedure. In contrast to the gate-based approach, GRAPE may not have the limitation incurred by the gate decomposition. Instead, the GRAPE-based approach directly searches for the optimal control pulse for the input circuit as a whole. Some embodiments described herein utilize GRAPE for portions of compilation, as described in further detail below.

In the example embodiment, the control computing device 110 includes a compilation engine 114 that, during operation, is configured to compile the variational quantum application program 112 (e.g., from source code) into an optimized physical schedule 116. The quantum computing device 130 is a superconducting device and the signal generator 118 is an arbitrary wave generator (“AWG”) configured to perform the optimized control pulses 120 on the quantum processor 132 (e.g., via microwave pulses sent to the qubits 134, where the axis of rotation is determined by the quadrature amplitude modulation of the signal and where the angle of rotation is determined by the pulse length of the signal). The optimized physical schedule 116 represents a set of control instructions and an associated schedule that, when sent to the quantum computing device 130 as optimized control pulses 120 (e.g., the pre-programmed control fields) by a signal generator 118, causes the quantum computing device 130 to execute the quantum program 112.

In the example embodiment, the optimized physical schedule 116 may represent a set of control instruction and an associated schedule corresponding to each quantum computing device 130 of the ensemble of quantum computing device to perform a respective quantum application operation of the quantum application operations.

An output from the ensemble of quantum devices may be measured and/or a metric may be generated by a metric generation module 140. By way of a non-limiting example, the metric generation module 140 may generate a quantum kernel alignment metric. Even though the metric generation module 140 is shown separate from the ensemble of quantum computing devices, the metric generation module 140 may be implemented on the ensemble of quantum computing devices 130s. It should be understood that other quantum computing architectures may have different supporting hardware.

In some example embodiments, the variational quantum program 112 may be a Variational Quantum Eigensolver (VQE). In these examples, the quantum computing system 100 may use VQE to find the ground state energy of a molecule. This task is exponentially difficult in general for a classical computer, but efficiently solvable by a quantum computer. Estimating the molecular ground state has important applications to chemistry such as determining reaction rates and molecular geometry. A conventional quantum algorithm for solving this problem is the Quantum Phase Estimation (QPE) algorithm. However, for target precision ε, QPE yields a quantum circuit with depth O(1/ε), whereas VQE algorithm yields O(1/ε²) iterations of depth O(1) circuits. The latter assumes a more relaxed fidelity requirement on the qubits and gate operations, because the higher the circuit depth, the more likely the circuit experiences an error at the end, and possibly a wrong output string may be generated from execution of the quantum application program.

Even if quantum computing devices are manufactured in a highly controlled setting, unavoidable variation may result in each quantum computing device to have different intrinsic properties. Due to each quantum computing device having different intrinsic properties, each quantum computing device's performance is impacted differently even if each quantum computing device is subjected to the same input conditions in a controlled environment. This variation (in intrinsic properties) between and within quantum computing devices becomes apparent while examining error rates.

As will be appreciated based upon the foregoing specification, the above-described embodiments of the disclosure may be implemented using computer programming or engineering techniques including computer software, firmware, hardware or any combination or subset thereof, wherein the technical effect is to compile and optimize a variational quantum program for execution on a quantum processor. Any such resulting program, having computer-readable code means, may be embodied, or provided within one or more computer-readable media, thereby making a computer program product, (e.g., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These conventional computer programs (also known as programs, software, software applications, “apps,” or code) include machine instructions for a conventional programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

### Exemplary Application Server or a Classical Computing Device

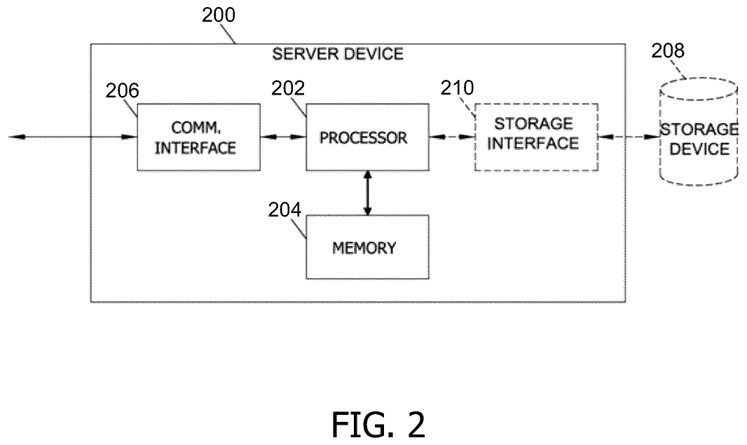

FIG. 2 depicts an exemplary configuration of an application server (or a classical computing device) 200, in accordance with one embodiment of the present disclosure. Application server 200 may be similar to the control computing device 110 (shown in FIG. 1), and may be configured to perform various operations, as described herein, that are performed using classical computing device or the control computing device 110. Processor 202 may include one or more processing units (e.g., in a multi-core configuration).

Processor 202 may be operatively coupled to a communication interface 206 such that the application server 200 is capable of communicating with a remote device, such as one or more quantum computing devices 130s via communication interface 206. For example, communication interface 206 may receive data, e.g., control pulses, image, video, text, and so on. By way of a non-limiting example, the application server 200 may be a server which may receive a classical data input and may generate a quantum feature map corresponding to the classical data input, and cause execution of the quantum feature map on the one or more quantum computing devices 130s.

Processor 202 may also be operatively coupled to a storage device 208. Storage device 208 may be any computer-operated hardware suitable for storing and/or retrieving data, such as, but not limited to, data associated with historic databases. In some embodiments, storage device 208 may be integrated in the application server 200. For example, the application server 200 may include one or more hard disk drives as storage device 208.

In other embodiments, storage device 208 may be external to host computing device 200 and may be accessed by a plurality of host computing devices 200. For example, storage device 208 may include a storage area network (SAN), a network attached storage (NAS) system, and/or multiple storage units such as hard disks and/or solid-state disks in a redundant array of inexpensive disks (RAID) configuration.

In some embodiments, processor 202 may be operatively coupled to storage device 208 via a storage interface 210. Storage interface 210 may be any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 202 with access to storage device 208.

Processor 202 may execute computer-executable instructions for implementing aspects of the disclosure. In some embodiments, the processor 202 may be transformed into a special purpose microprocessor by executing computer-executable instructions or by otherwise being programmed. In some embodiments, and by way of a non-limiting example, the memory 204 may include instructions to perform specific operations, as described herein.

### Exemplary Computer-Implemented Method

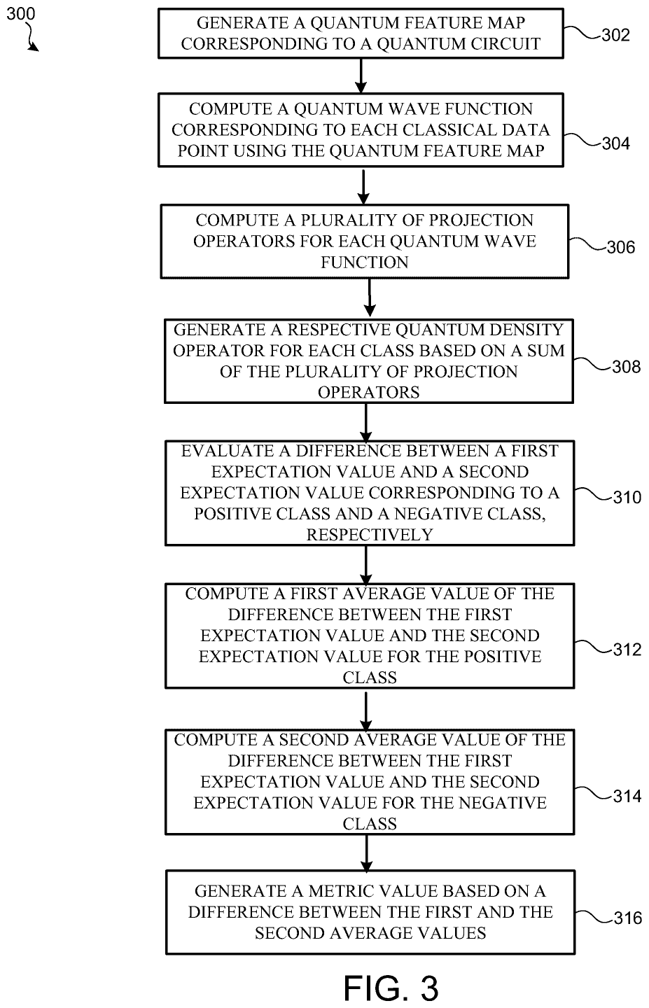

FIG. 3 depicts a process flow-chart 300 for an exemplary computer-implemented method operations performed by a classical computing device such a control computing device 110. A quantum feature map may be generated (302) corresponding to a quantum circuit received by the control computing device 110 from a user. The quantum feature map corresponds with a classical-to-quantum mechanical representation. In other words, for each classical data input, a corresponding quantum mechanical representation of a quantum circuit may be generated. For the generated (302) quantum feature map, a quantum wave function corresponding to each classical data input may be generated (304). As described herein, a quantum wave function is a mathematical object that encodes the classical data and/or provides a mathematical description of a quantum state of the qubits of the quantum computing device.

For each generated quantum wave function, a plurality of projection operators may be computed (306). A projection operator of the plurality of projection operations may specify a way of determining a probability of measuring a particular observation for a system in a specific given state. A respective quantum density operator for each class, for example, a positive class and a negative class, may be generated (308) by adding a plurality of projection operators to calculate a sum of the plurality of projection operators and dividing the sum of the plurality of projection operators with a total number of projection operators of the plurality of projection operators.

For each quantum wave function corresponding to each classical data point, a difference between a first expectation value corresponding to a positive class for the respective quantum density operator and a second expectation value corresponding to a negative class for the respective quantum density operator may be evaluated (310). For each classical data point x, the first expectation value for the positive class may be represented as g₊(x), and the second expectation value for the negative class may be represented as g₋(x). The difference between the g₊(x) and g₋(x) may be represented as f(x), where f(x)=g₊(x)−g₋(x).

A first average value of the difference between the first expectation value and the second expectation value for each classical data point in the positive class may be computed (312). The first average value may be computed (312) by subtracting 1/N from the difference between the first expectation value and the second expectation value, where N represents a total count of classical data points in the positive class. A second average value of the difference between the first expectation value and the second expectation value for each classical data point in the negative class may be computer (314). The second average value may be computed by adding 1/N to the difference between the first expectation value and the second expectation value, where N represents a total count of classical data points in the negative class.

Based upon a difference between the first average value and the second average value, a metric value may be generated (316). One way to combine the positive and negative scores (or the first average value and the second average value) is by taking their difference to produce a result equivalent to the alignment metric (with an emergent reference kernel) that is interpreted as a metric for proving the validity of kernel alignment (with the emergent reference kernel). Other ways to combine the positive and negative scores may include normalizing their difference further by their sum. The difference between the first average value and the second average value may range from −2 to +2. The metric value may be used to evaluate strength of the quantum feature map. A higher value of the difference between the first average value and the second average value may indicate the quantum feature map is more accurate in separating different classes of data in comparison with a lower value of the difference between the first average value and the second average value for the quantum feature map. By way of a non-limiting example, the quantum feature map may be a variation quantum feature map including one or more additional variational parameters for tuning properties of the one or more additional variational parameters.

### Another Exemplary Computer-Implemented Method

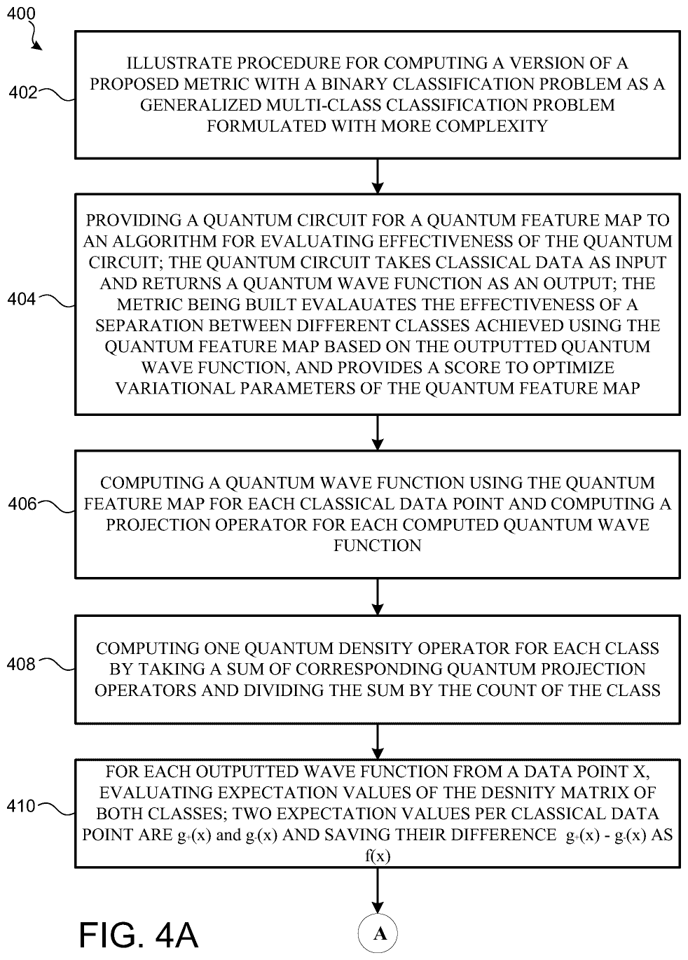

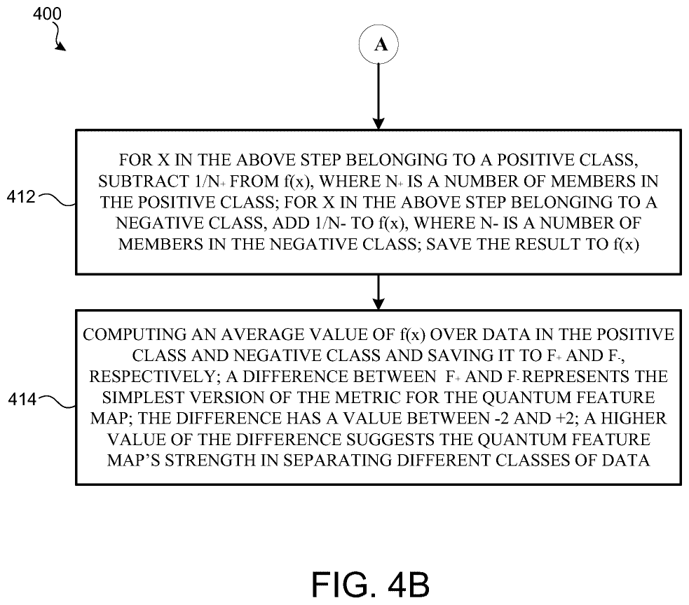

FIGS. 4A-4B depict another flow-chart of an exemplary computer-implemented method 400 performed by a classical computing device such as the control computing device shown in FIG. 1. The operations of the method 400 include illustrating 402 a procedure for computing a version of a proposed metric with a binary classification problem as a generalized multi-class classification problem formulated with more complexity.

Method 400 further includes providing 404 a quantum circuit for a quantum feature map to an algorithm for evaluating an effectiveness of the quantum circuit. The quantum circuit may take classical data as input and return a quantum wave function as an output. The proposed metric being built is for evaluating the effectiveness of the quantum feature map in achieving a separation between different classes based upon the quantum wave function generated as its output. For variational feature maps (or feature maps having additional “variational” parameters to tune their properties), the proposed metric may be used as a score to optimize the variational parameters.

Method 400 further includes computing 406 a quantum wave function, for each classical data point, using the quantum feature map, and computing a projection operator for each wave function. Method 400 further includes computing 408 one quantum density operator for each class by taking the sum of the corresponding quantum projection operators for each class, and dividing the sum by the count of (or a total number of) classes to generate a quantum density operator for each class.

Method 400 further includes for each outputted wave function from a data point x, evaluating 410 expectation values of the density matrix of both classes for each wave function produced from a data point x. Accordingly, two expectation values, g₊(x) and g₋(x), per classical data point may be evaluated, and their difference may be saved as f(x), where f(x)=g₊(x)−g₋(x).

Method 400 further includes, if x is determined as belonging to a positive class, 1/N₊ may be subtracted 412 from f(x), and if x is determined as belonging to a negative class, 1/N₋ may be added to f(x), where N₊ and N₋ represent the number of members in the positive class and the negative class, respectively.

Method 400 further includes computing 414 an average value of f(x) over data in the positive class and saving it to F₊ and computing an average value of f(x) over data in the negative class and saving it to F₋. Accordingly, one version of the proposed metric for the feature map may be computed as F=F₊−F₋, where a value of F may range from −2 to +2. Further, a higher value of F may indicate a more powerful feature map in separating different classes of data. In other words, a greater value of the difference between F₊ and F₋ may indicate that the quantum feature map is more accurate in separating different classes of data compared with a lesser value of the difference between F₊ and F₋ for the quantum feature map.

### Exemplary Embodiments

In today's hybrid quantum machine learning algorithms, a crucial—and arguably the most important—part is in translating classical data to their quantum mechanical representation. Such representations, due to the potential in leveraging uniquely quantum characteristics, such as entanglement, are believed to offer new insight into the data that may be hard to come by in classical data embedding techniques. How good the quantum representation is may place a fundamental upper limit in the predictive power of the overall learning algorithm. Once this translation is accomplished, the task to learn from the quantum representation may either be handed over to a classical algorithm—an example being the Quantum Support Vector Machine—or to other quantum processes, such as variational quantum circuits, if further quantum advantages can be expected to be leveraged (in for example, finding the classifying hyperplane).

As important as it is, currently there is no consensus on how to evaluate the effectiveness of this classical-to-quantum translation, known in the literature as “quantum feature map.” This may be partly due to the pragmatic nature of traditional machine learning, where the effectiveness of any component of an algorithm is ultimately judged by the eventual learning outcome. It does not help, that due perhaps to the practicality (or lack thereof) of direct measurement of a quantum wave function (the mathematical object that encodes classical data), even quantum machine learning practitioners may tend to hasten the transition away from the wave function picture in favor of descriptions more conformant to traditional machine learning, such as the kernel matrix, thereby leaving on the table additional insights that one could have gleaned from the quantum (i.e., wave function) description.

This type of thinking has led to the development of metrics such as the so-called quantum kernel alignment (from IBM), which is the application of a classical technique called kernel alignment, to the kernel derived from quantum wave functions, as a way to evaluate and optimize quantum feature maps. The drawbacks are that (1) it is based on an arbitrary choice of what is known as a reference kernel—a different reference kernel choice would give a different evaluation of the feature map and therefore a different optimal. In a way, this shifts part of the problem to the evaluation of the choice of a reference kernel, a problem often not addressed in related studies. (2) The technique is closely related to—and indeed motivated by—the traditional support vector machine algorithm, meaning the evaluation is based upon the predictive performance of support vector machine, and is therefore not an intrinsic measure of the feature map itself.

The inventors have developed a metric for evaluating quantum feature maps based purely on the feature map itself. The metric is based upon the notion of quantum density matrices, which is the natural language in quantum physics for describing a collection of quantum wave functions resulting from some physical experiment. Here, the inventors are making the analogy that a quantum feature map is like a physics experiment—it takes in experimental parameters (in this case the classical data), and produces a quantum state as an outcome, and the ensemble (roughly, physics lingo for “collection”) of quantum states produced by repeated experiments (sampling of classical data) is naturally described by density matrices. In the simplest version of this metric where we do not concern ourselves with probabilistic normalization, it may be expressed as a form of kernel alignment, but notably with a different reference kernel than that used in typical SVM-based kernel alignment measures.

Interestingly, the reference kernel shares certain mathematical constraints imposed on the SVM reference kernel, indicating that such constraints may, after all, have a physical origin. In a more elaborate version of the metric (with probabilistic normalization and other considerations), it can no longer be formulated as a kernel alignment—mathematically, it can no longer be expressed as a quadratic form of the elements of the kernel matrix. The latter, more elaborate version is being developed and its many ramifications deriving from its deviation from the traditional kernel alignment procedure are being investigated, which, ultimately, come from the fundamental difference going into the design of such a metric.

Further, exemplary aspects of the systems and methods described herein are provided hereinbelow with certain embodiments being described.

In one embodiment, a classical computing device comprising: at least one memory; and at least one processor in communication with the at least one memory, wherein the at least one processor is programmed to: (i) generate a quantum feature map corresponding to a quantum circuit; (ii) using the quantum feature map, compute a quantum wave function corresponding to each classical data point; (iii) compute a plurality of projection operators for each quantum wave function corresponding to each classical data input; (iv) generate a respective quantum density operator for a positive class and a negative class based upon a sum of the plurality of projection operators and a count of the plurality of projection operators; (v) for each quantum wave function corresponding to each classical data point, evaluate a difference between a first expectation value corresponding to the positive class for the respective quantum density operator and a second expectation value corresponding to the negative class for the respective quantum density operator; (vi) compute a first average value of the difference between the first expectation value and the second expectation value for each classical data point in the positive class; (vii) compute a second average value of the difference between the first expectation value and the second expectation value for each classical data point in the negative class; and/or (viii) based upon a difference between the first average value and the second average value, generate a kernel alignment metric value. As a result, the operation and/or efficiency of the device may be enhanced. The device may include additional, less, or alternate functionality, including that discussed elsewhere herein.

For instance, with the classical computing device in accordance with any of the preceding clauses, the at least one processor may be further programmed to subtract/N from the difference between the first expectation value and the second expectation value to compute the first average value. N may represent a total count of classical data points in the positive class.

Also, with the classical computing device in accordance with any of the preceding clauses, the at least one processor may be further programmed to add 1/N to the difference between the first expectation value and the second expectation value to compute the second average value. N may represent a total count of classical data points in the negative class.

Further, with the classical computing device in accordance with any of the preceding clauses, the difference between the first average value and the second average value may range from −2 to +2, in some embodiments.

Additionally, with the classical computing device in accordance with any of the preceding clauses, the at least one processor may be further programmed to, based upon the difference between the first average value and the second average value, evaluate a strength of the quantum feature map.

With the classical computing device in accordance with any of the preceding clauses, a greater value of the difference between the first average value and the second average value may indicate the quantum feature map is more accurate in separating different classes of data compared with a lesser value of the difference between the first average value and the second average value for the quantum feature map. Additionally, or alternatively, with the classical computing device in accordance with any of the preceding clauses, the quantum feature map may be a variation quantum feature map including one or more additional variational parameters for tuning properties of the one or more additional variational parameters.

In another aspect, a computer-implemented method may enhance operation and/or efficiency of a classical computing device, quantum circuit and/or quantum feature map; improve the effectiveness of the classical computing device, quantum circuit and/or quantum feature map; and/or optimize variational parameters. The method may be implemented via one or more local or remote processors, and include, via one or more local or remote processors: (i) generating a quantum feature map corresponding to a quantum circuit; (ii) using the quantum feature map, computing a quantum wave function corresponding to each classical data point; (iii) computing a plurality of projection operators for each quantum wave function corresponding to each classical data input; (iv) generating a respective quantum density operator for a positive class and a negative class based upon a sum of the plurality of projection operators and a count of the plurality of projection operators; (v) for each quantum wave function corresponding to each classical data point, evaluating a difference between a first expectation value corresponding to the positive class for the respective quantum density operator and a second expectation value corresponding to the negative class for the respective quantum density operator; (vi) computing a first average value of the difference between the first expectation value and the second expectation value for each classical data point in the positive class; (vii) computing a second average value of the difference between the first expectation value and the second expectation value for each classical data point in the negative class; and/or (viii) based upon a difference between the first average value and the second average value, generating a kernel alignment metric value. The method may include additional, less, or alternate functionality, including that discussed elsewhere herein.

For instance, the computer-implemented method in accordance with any of the preceding clauses may further comprise subtracting 1/N from the difference between the first expectation value and the second expectation value to compute the first average value. N may represent a total count of classical data points in the positive class. Additionally, or alternatively, N may represent a total count of classical data points in the negative class. Further, the difference between the first average value and the second average value ranges from −2 to +2.

The computer-implemented method may further include, based upon the difference between the first average value and the second average value, evaluating a strength of the quantum feature map. Additionally or alternatively, with the computer-implemented method in accordance with any of the preceding clauses, a greater value of the difference between the first average value and the second average value indicates the quantum feature map is more accurate in separating different classes of data compared with a lesser value of the difference between the first average value and the second average value for the quantum feature map.

Also, with the computer-implemented method in accordance with any of the preceding clauses, the quantum feature map may be a variation quantum feature map including one or more additional variational parameters for tuning properties of the one or more additional variational parameters.

### Exemplary Use Cases or Applications

As described herein, in today's hybrid quantum machine learning algorithms, a crucial—and arguably the most important—part is in translating classical data to their quantum mechanical representation. Such representations are believed to offer new insights into the data that may be hard to come by in classical data embedding techniques, and how good the quantum representation is may place a fundamental upper limit in the predictive power of the overall learning algorithm. Once this translation is accomplished, the task to learn from the quantum representation may either be handed over to a classical algorithm—an example being the Quantum Support Vector Machine—or to other quantum processes, such as variational quantum circuits, if further quantum advantages can be expected to be leveraged, for example, in finding the classifying hyperplane.

The classifying hyperplane provides a decision boundary dividing the input space into two or more regions, where each region may correspond to a different class or output label. The hyperplane in a 2D space may divide the space into two regions representing different classes using a straight line, and the hyperplane in a 3D space may divide the space into two halves representing different classes using a plane. Further, in higher-dimensional spaces, a hyperplane may be a subspace of one dimension less than the input space.

As described herein, a density matrix based metric may correctly identify a theoretical best parameter value corresponding to the most effective feature map. The most effective feature map is a feature map that is most effective in representing data, which may include vague data, pristine data, and/or noisy data. Additionally, or alternatively, the density matrix based metric may be used as an objective function to iteratively improve parametrized quantum feature maps, which in turn may improve the accuracy of a standard SVM algorithm in a binary classification task (e.g., a positive class and a negative class).

Various applications where data points are required to be identified as being associated with a particular class or having a specific output label may include, but are not limited to, a risk assessment application such as solvency monitoring (identifying a dividing line between solvent companies and insolvent companies), individual claim reserving, aggregate claim reserving, insurance applications, insurance quote generation, insurance claim handling and processing, subrogation applications, and/or insurance fraud detection. Data points may be associated with telematics data, smart home data, user questionnaire, survey answers, etc. Accordingly, various embodiments of the systems and methods described herein may offer significant benefits in the applications mentioned above.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device comprising:
at least one memory; and
at least one processor in communication with the at least one memory, wherein the at least one processor is programmed to:
generate a quantum feature map corresponding to a quantum circuit;
using the quantum feature map, compute a quantum wave function corresponding to each classical data point;
compute a plurality of projection operators for each quantum wave function corresponding to each classical data input;
generate a respective quantum density operator for a positive class and a negative class based upon a sum of the plurality of projection operators and a count of the plurality of projection operators;
for each quantum wave function corresponding to each classical data point, evaluate a difference between a first expectation value corresponding to the positive class for the respective quantum density operator and a second expectation value corresponding to the negative class for the respective quantum density operator;
compute a first average value of the difference between the first expectation value and the second expectation value for each classical data point in the positive class;
compute a second average value of the difference between the first expectation value and the second expectation value for each classical data point in the negative class; and
based upon a difference between the first average value and the second average value, generate a metric value.

2. The computing device of claim 1, wherein the at least one processor is further programmed to:
subtract 1/N from the difference between the first expectation value and the second expectation value to compute the first average value, where N represents a total count of classical data points in the positive class.

3. The computing device of claim 1, wherein the at least one processor is further programmed to:
add 1/N to the difference between the first expectation value and the second expectation value to compute the second average value, where N represents a total count of classical data points in the negative class.

4. The computing device of claim 1, wherein the difference between the first average value and the second average value ranges from −2 to +2.

5. The computing device of claim 1, wherein the at least one processor is further programmed to: based upon the difference between the first average value and the second average value, evaluate a strength of the quantum feature map.

6. The computing device of claim 5, wherein a greater value of the difference between the first average value and the second average value indicates that the quantum feature map is more accurate in separating different classes of data compared with a lesser value of the difference between the first average value and the second average value for the quantum feature map.

7. The computing device of claim 1, wherein the quantum feature map is a variation quantum feature map including one or more additional variational parameters for tuning properties of the one or more additional variational parameters.

8. The computing device of claim 1, wherein the quantum feature map is used for separating different classes of data in a risk assessment application.

9. A computer-implemented method implemented by at least one processor in communication with at least one memory, the method comprising:
generating a quantum feature map corresponding to a quantum circuit;
using the quantum feature map, computing a quantum wave function corresponding to each classical data point;
computing a plurality of projection operators for each quantum wave function;
generating a respective quantum density operator for a positive class and a negative class based upon a sum of the plurality of projection operators and a count of the plurality of projection operators;
for each quantum wave function corresponding to each classical data point, evaluating a difference between a first expectation value corresponding to the positive class for the respective quantum density operator and a second expectation value corresponding to the negative class for the respective quantum density operator;
computing a first average value of the difference between the first expectation value and the second expectation value for each classical data point in the positive class;
computing a second average value of the difference between the first expectation value and the second expectation value for each classical data point in the negative class; and
based upon a difference between the first average value and the second average value, generating a metric value.

10. The computer-implemented method of claim 9, further comprising:
subtracting 1/N from the difference between the first expectation value and the second expectation value to compute the first average value, where N represents a total count of classical data points in the positive class.

11. The computer-implemented method of claim 9, further comprising:
adding 1/N to the difference between the first expectation value and the second expectation value to compute the second average value, where N represents a total count of classical data points in the negative class.

12. The computer-implemented method of claim 9, wherein the difference between the first average value and the second average value ranges from −2 to +2.

13. The computer-implemented method of claim 9, further comprising, based upon the difference between the first average value and the second average value, evaluating a strength of the quantum feature map.

14. The computer-implemented method of claim 13, wherein a greater value of the difference between the first average value and the second average value indicates that the quantum feature map is more accurate in separating different classes of data compared with a lesser value of the difference between the first average value and the second average value for the quantum feature map.

15. The computer-implemented method of claim 9, wherein the quantum feature map is a variation quantum feature map including one or more additional variational parameters for tuning properties of the one or more additional variational parameters.

16. The computer-implemented method of claim 9, wherein the quantum feature map is used for separating different classes of data in a risk assessment application.

17. A non-transitory computer-readable medium (CRM) embodying programmed instructions which, when executed by at least one processor of a computing device, cause the at least one processor to:
generate a quantum feature map corresponding to a quantum circuit;
using the quantum feature map, compute a quantum wave function corresponding to each classical data point;
compute a plurality of projection operators for each quantum wave function corresponding to each classical data input;
generate a respective quantum density operator for a positive class and a negative class based upon a sum of the plurality of projection operators and a count of the plurality of projection operators;
for each quantum wave function corresponding to each classical data point, evaluate a difference between a first expectation value corresponding to the positive class for the respective quantum density operator and a second expectation value corresponding to the negative class for the respective quantum density operator;
compute a first average value of the difference between the first expectation value and the second expectation value for each classical data point in the positive class;
compute a second average value of the difference between the first expectation value and the second expectation value for each classical data point in the negative class; and
based upon a difference between the first average value and the second average value, generate a metric value.

18. The non-transitory CRM of claim 17, wherein the instructions further cause the at least one processor to, based upon the difference between the first average value and the second average value, evaluate a strength of the quantum feature map.

19. The non-transitory CRM of claim 18, wherein a greater value of the difference between the first average value and the second average value indicates that the quantum feature map is more accurate in separating different classes of data compared with a lesser value of the difference between the first average value and the second average value for the quantum feature map.

20. The non-transitory CRM of claim 17, wherein the quantum feature map is used for separating different classes of data in a risk assessment application.
